(19) United States
(12) Patent Application Publication
(10) Pub. No.: US 2023/0252478 A1
(43) Pub. Date: Aug. 10, 2023

(54) CLUSTERING DATA VECTORS BASED ON DEEP NEURAL NETWORK EMBEDDINGS

(71) Applicant: PAYPAL, INC., San Jose, CA (US)

(72) Inventors: Moein Saleh, Campbell, CA (US); Chiara Poletti, San Jose, CA (US); Shiying He, Jersey City, NJ (US); Sina Modaresi, Campbell, CA (US); Xing Ji, San Jose, CA (US)

(21) Appl. No.: 17/667,353

(22) Filed: Feb. 8, 2022

(51) Int. Cl. G06Q 20/40; G06N 3/04; G06N 3/08

(52) U.S. Cl. CPC G06Q 20/4016; G06N 3/0472; G06N 3/08

(57) ABSTRACT

There are provided systems and methods for clustering data vectors based on deep neural network embeddings. A service provider, such as an electronic transaction processor for digital transactions, may provide computing services to users. In order to provide actionable insights into users, accounts, and/or activities associated with the service provider, the service provider may provide clustering of deep embeddings from an embedding layer of a deep neural network model. The clustering may be improved to handle and utilize temporal data, such as time sensitive and/or changing data, using a long short-term memory model with sequential data. The embedding layer may be trained and used for embedding generation using a distribution-wise objective function and a silhouette score to determine cluster membership, cluster loss, and the number of clusters. Once trained, data records may be clustered and relationships between different data records may be identified for taking next-best-actions.

### TECHNICAL FIELD

The present application generally relates to clustering of machine learning (ML) and/or neural network (NN) vectors, and more particularly to clustering data records using deep learning embeddings for enhanced identification of cluster participant relationships.

### BACKGROUND

Online service providers may provide services to different users, such as individual end users, merchants, companies, and other entities. For example, online transaction processors may provide electronic transaction processing services. When providing these services, the service providers may provide an online platform that may be accessible over a network, which may be used to access and utilize the services provided to different users. The service providers may use intelligent decision-making operations to make comparisons to past occurrences, which may be helpful in assisting customers. Clustering operations and algorithms may be utilized to attempt to identify similar customers, accounts, and/or transactions, and provide cross-services and offers. However, conventional clustering is not time dependent and focuses on a set of time periods. Thus, conventional clustering operations may be insufficient to calculate adequate similarities between data for modern intelligent data processing platforms.

Therefore, there is a need for a more efficient and temporally relevant clustering operation that provides better intelligent decision-making in automated systems.

### BRIEF DESCRIPTION OF THE DRAWINGS

FIG. 1 is a block diagram of a networked system suitable for implementing the processes described herein, according to an embodiment;

FIG. 2 is an exemplary deep neural network having an embedding layer used for clustering of data records, according to an embodiment;

FIG. 3 is an exemplary diagram of data record clustering that may be performed based on embeddings from an embedding layer of a deep neural network, according to an embodiment;

FIG. 4 is a flowchart for clustering data vectors based on deep neural network embeddings, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for clustering data vectors based on deep neural network embeddings. Systems suitable for practicing methods of the present disclosure are also provided.

In network communications, such as between online platforms and systems for service providers and end user devices, electronic platforms and computing architecture may provide computing services to users and computing devices. For example, online transaction processors may provide computing and data processing services for electronic transaction processing between two users or other entities (e.g., groups of users, merchants, businesses, charities, organizations, and the like). In order to assist in providing computing services to users, customers, merchants, and/or other entities, services providers may attempt to identify relationships between different users, accounts, activities, behaviors, actions, marketing, and the like based on past collected and/or aggregated data. This enables more intelligent decision-making that may lead to desired and actionable decisions on extensions of computing services and the like to different users. In order to do so, a service provider may cluster customers, accounts, or the like based on available data. However, deriving desired and actionable clusters are not easily structured and optimized for long-term temporal data and dependencies in customer or user data. Thus, service providers may not properly cluster data records for different users, accounts, and the like to provide optimized actionable decisions for customers.

In this regard, a service provider may utilize embeddings or vectors of data generated by a layer of a deep neural network model, in order to better cluster data records and make associations between corresponding customers, accounts, or the like. Data records may correspond to data in one or more data tables that include different parameters and/or features. For example, a data record may include a row in a data table having features from a set of features corresponding to the different columns of the data table. A user may have a record that may include an account, a processed transaction, an amount, transaction items, etc., which may be found in the columns for the correspond data record in a row. The features and/or data records may also have a corresponding temporal factor, dimensionality, and/or information, such as actions taken over time (e.g., processed transactions over a time period, changing account balance, etc.).

However, conventional clustering by service providers may focus on just a snapshot in time, which does not include the temporal information and/or time-based data. This clustering may be performed using the features of the data records, which may not include a vector that has a temporal dimensionality and/or variable. Thus, the service provider may utilize a deep neural network (DNN) model and/or framework to provide deep temporal-based clustering. The DNN model may use a long short-term memory (LSTM) recurrent neural network architecture, where temporal features are used as input. However, other neural networks (NNs), machine learning (ML) models, and other artificial intelligence (AI) systems and models may also be used. The DNN model may be trained for a predictive score, classification, or output variable associated with input features. The predictive output, such as the score, decision, or other value, may further be used to classify or categorize an account, user, activity, or the like.

Initially, the service provider may train the DNN model using training data to perform these classifications and/or categorizations. However, when training, a distribution-wise objective function may be used with one (or multiple) hidden layers, such as embedding layer(s), of the DNN model to calculate cluster membership and clustering loss. The objective function may include normal distribution, Weibull distribution, or the like, which may be selected and/or configurable using a model training framework and system. The objective function may be selected based on the specific task of the DNN for intelligent decision-making and predictive outputs and/or the input training data. Further, the number of output clusters from clustering using an embedding layer of the DNN may not be required to be pre-selected by the modeler, data scientist, conventional methodology (e.g., mean squared error, elbow method, etc.), or the like during model training. Instead, a silhouette score may be used, which allows for clustering performance evaluation. Once trained and when clustered using the DNN model, output embeddings from an embedding layer may be used. These embeddings may correspond to vectors that reduce the dimensionality of the input feature data for the input features of the DNN model. The embeddings allow for time-sensitive data clustering, which allows similarities and relationships between users, accounts, activities, or the like to be deduced based on the clustered data records. Thereafter, a next-best-action or other action may be performed to provide additional computing services, value, and the like to users, accounts, and the like.

For example, a service provider may provide electronic transaction processing to users and entities through digital accounts, including consumers and merchants that may wish to process transactions and payments and/or perform other online activities. The service provider may also provide computing services, including email, social networking, microblogging, media sharing, messaging, business and consumer platforms, etc. In order to establish an account, these different users may be required to provide account details, such as a username, password (and/or other authentication credential, such as a biometric fingerprint, retinal scan, etc.), and other account creation details. The account creation details may include identification information to establish the account, such as personal information for a user, business or merchant information for another entity, or other types of identification information including a name, address, and/or other information. The entity may also be required to provide financial or funding source information, including payment card (e.g., credit/debit card) information, bank account information, gift card information, benefits/incentives, and/or financial investments, which may be used to process transactions. The online payment provider may provide digital wallet services, which may offer financial services to send, store, and receive money, process financial instruments, and/or provide transaction histories, including tokenization of digital wallet data for transaction processing. The application or website of the service provider, such as PayPal® or other online payment provider, may provide payments and the other transaction processing services.

An online transaction processor or other service provider may execute operations, applications, decision services, and the like that may be used to process transactions between two or more users or entities. When providing computing services to users or other entities, as well and as making other business decisions, the service provider may generate clusters of users, accounts, activities, entities, or the like that may be actionable to determine relationships and/or similarities and provide recommendations, actions, marketing or advertisement, and the like in a predictive manner. Initially, the service provider may train a DNN or other ML model for a predictive output or classification so that an embedding layer may be used for clustering of users, accounts, activities, entities, or the like. In order to train the DNN or other ML models, training data for the models may be collected and/or accessed. The training data may correspond to a set or collection of features from some input data records, which may be associated with users, customers, accounts, activities, entities, and/or the like. The training data may be collected, aggregated, and/or obtained for a particular predictive output and/or classifications by the DNN. For example, a DNN may be associated with classifying users or accounts, predicting whether the users or accounts will engage in a behavior and/or perform an activity, or the like. For example, the DNN may be used to classify users as engaged or not engaged with the service provider (e.g., based on past behaviors and the like), if users or accounts are risky or not or otherwise may be engaged in fraud or likely to commit fraud, whether accounts or email addresses are valid/legitimate or likely established by fraudulent or malicious parties, and the like.

The training data for the DNN may be used to train the DNN initially using a DNN training architecture and framework. In this regard, an LSTM training framework may be used to train an LSTM model, where during training, additional operations may be performed in order to optimize the LSTM or other DNN model for an embedding layer used for clustering of data records and/or corresponding users, entities, accounts, activities, or the like with temporal information and/or features. For example, when training the DNN model, an embedding layer may correspond to one of the hidden layers where the dimensionality of corresponding input feature data for features is reduced. This may be done by creating mathematical relationships based on the DNN or LSTM algorithm to generate predictions and other decision-making, such as a predictive score or classification. The embedding layer may therefore provide a vector of n-dimensionality, where n corresponds to the input features and the vector is used to reduce the individual data points or features for the corresponding data record (e.g., by reducing the number of individual data pieces for the data record). The DNN model trainer may perform feature extraction to extract features and/or attributes used to train the DNN model. For example, training data features may correspond to those data features which allow for decision making by nodes of a DNN model. In this regard, a feature may correspond to data that may be used to output a decision by a particular node, which may lead to further nodes and/or output decisions by the DNN model. LSTM may be used in order to provide a temporal dimension to the input feature data and corresponding features or variables.

During training, the embedding layer may be used to cluster embeddings generated from the embedding layer (e.g., one of the hidden layers before an output layer). A distribution-wise object function may be used to calculate cluster membership during training and/or clustering loss. Training may be performed and new training data and/or adjustments to weights and/or classifications by the DNN may be provided until a loss function is satisfied for data record clustering using the embeddings from the embedding layer. The distribution-wise objective function may be used to provide a probability that a certain number, spread, or the like of clusters is satisfied, and may correspond to normal distribution, Weibull distribution, or another distribution available for an objective function. This may be selectable by the modeler and/or data scientist using the DNN model training framework. For example, normal distribution may be used if there is an assumption that some clusters at the tails or outer clustering boundaries/distribution may have a low number of points, data records, or the like, while those in the middle may be common and contain a large number of samples or points. In contrast, when identifying anomalies, such as fraud or unexpected behaviors that are very uncommon with a data set of data records, Weibull distribution may be used to identify these more uncommon clusters and samples.

Conventionally during training, the number of clusters is a hyperparameter of the DNN model training, such that a modeler or data scientist may be required to select the output number of clusters. The number of clusters may also conventionally be a value decided based on the elbow method or mean squared error. However, when training the DNN and adjusting the embedding layer to satisfy the loss function using the DNN or LSTM model training framework, a silhouette score may instead be used for an automatic number of cluster selection and/or assignment instead of being a hyperparameter that requires modeler selection and/or input. A silhouette score or coefficient may correspond to a metric used to determine and/or validate consistency within clusters of data and/or how well the clusters are performing in classifying data and clustering that data (e.g., the embeddings from the input training data and/or feature data for the DNN or LSTM model). This allows for identification of how similar a data record is to its corresponding cluster and how different from nearby or neighboring clusters, which allows for determination of whether there are too many or too few clusters and automatic cluster generation. Once the DNN model is trained, an output layer may be used for output decision or predictive scores, where a hot encoding based on those scores may be used for an output classification (e.g., engaged/not engaged, fraudulent or valid, malicious/suspicious activity or proper behavior, etc.).

Thereafter, data records for users, accounts, entities, activities, or the like may be accessed and used with the trained DNN model. Embeddings may be generated by the embedding layer and thereafter output for a clustering operation or algorithm used for the embeddings. The clustering operation and/or algorithm may correspond to a selected operation, which may cluster based on the distribution-wise objective function and/or membership distribution, vectors or other mathematical representations from the embeddings, clusters and/or cluster sizes, and the like. Once clustered, relationships and/or similarities may be made or inferred based on membership within a cluster, such as by inferring that users and/or accounts in the cluster behavior similarly. Thus, if a significant portion of the cluster exhibits some behavior or have past data, which may be temporally related, other members of the cluster may similarly be interested in or predicted to follow that behavior or later engage in that activity, action, or other future data. Thus, one or more next-best-actions or future predicted event may be provided to members of that cluster for further engagement or predicted benefits and interests.

For example, events and/or promotional messages may be transmitted to other users within a cluster based on the members of that cluster. In some embodiments, if a user is clustered with other users that are highly engaged, but the user is not highly engaged, other features and past activities of the other users may be used to provide the user with a promotional activity or message for a next-best-action in order to enhance user engagement and/or maximize a customer lifetime value of the customer. Thus, the service provider may provide automated messaging and predictive clustering in a more accurate and time-based manner. By performing this automatically using clustered data records from embeddings by a DNN model, the service provider may reduce processing time, cost, and resource usage when clustering data, thereby providing improved data processing systems. This also reduces processing loads and network communication consumption for service provider systems, which further improves performance of such data processing and computing systems. Further, the online transaction processor may provide better predictive services and more accurate data clustering, which improves intelligent DNN model performance.

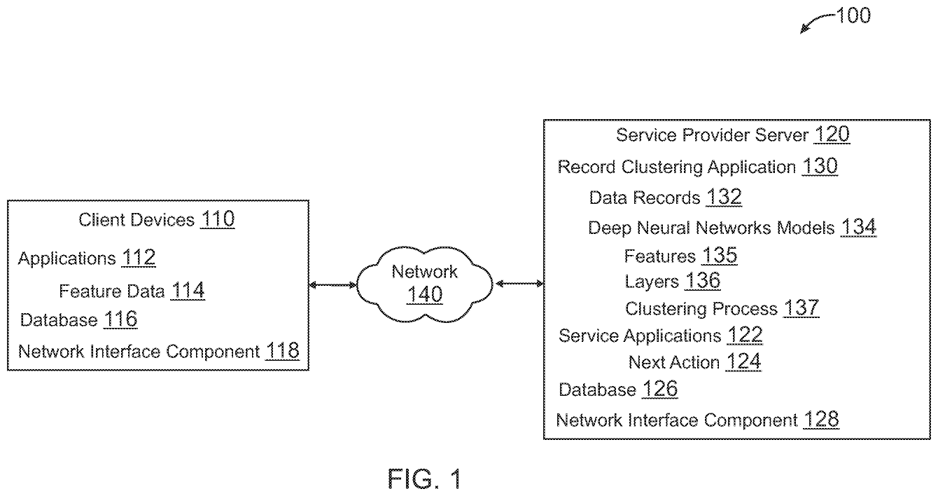

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity.

System 100 includes client devices 110 and a service provider server 120 in communication over a network 140. Client devices 110 may be utilized by users or other entities to interact with service provider server 120 over network 140, where service provider server 120 may provide various computing services, data, operations, and other functions over network 140. In this regard, client devices 110 may perform activities with service provider server 120 for account establishment and/or usage, electronic transaction processing, and/or other computing services. Service provider server 120 may receive feature data for a DNN that corresponds to data records associated with a user, account, or the like. Service provider server 120 may provide clustering of the users, data records, or other input feature data in order to determine relationships and/or similarities for providing recommendations and next-best-actions.

Client devices 110 and service provider server 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

Client devices 110 may be implemented as computing and/or communication devices that may utilize appropriate hardware and software configured for wired and/or wireless communication with service provider server 120. For example, in one embodiment, one or more of client devices 110 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data. Although a plurality of devices are shown and described herein, a single device may function similarly and/or be connected to provide the functionalities described herein.

Client devices 110 of FIG. 1 contain applications 112, databases 116, and network interface components 118. Applications 112 may correspond to executable processes, procedures, and/or applications with associated hardware. In other embodiments, client devices 110 may include additional or different modules having specialized hardware and/or software as required.

Applications 112 may include one or more processes to execute software modules and associated components of client devices 110 to provide features, services, and other operations to users from service provider server 120 over network 140, which may include account, electronic transaction processing, and/or other computing services and features from service provider server 120. In this regard, applications 112 may correspond to specialized software utilized by users of client devices 110 that may be used to access a website or application (e.g., mobile application, rich Internet application, or resident software application) that may display one or more user interfaces that allow for interaction with service provider server 120, for example, to access and account, process transactions, and/or otherwise utilize computing services. In various embodiments, applications 112 may correspond to one or more general browser applications configured to retrieve, present, and communicate information over the Internet (e.g., utilize resources on the World Wide Web) or a private network. For example, each of applications 112 may provide a web browser, which may send and receive information over network 140, including retrieving website information, presenting the website information to the user, and/or communicating information to the website. However, in other embodiments, applications 112 may correspond to one or more dedicated applications of service provider server 120 or other entity (e.g., a merchant) for transaction processing via service provider server 120.

Applications 112 may be associated with account information, user financial information, and/or transaction histories for electronic transaction processing, including processing transactions using financial instrument or payment card data. Such data may correspond to feature data 114 that may be used to train DNN models, such as using a LSTM recurrent neural network architecture. Feature data 114 may include one or more data records, which may be stored and/or persisted in a database and/or data tables accessible by service provider server 120. In further embodiments, feature data 114 may also or instead be used as input data to a trained DNN model, which may utilize feature data 114 for clustering of users, accounts, data records, or the like, as well as provide predictive decision-making and/or classifications by the DNN model.

Applications 112 may be utilized to enter, view, and/or process items the user wishes to purchase in a transaction, as well as perform peer-to-peer payments and transfers. In this regard, applications 112 may provide transaction processing through a user interface enabling the user to enter and/or view the items that the users associated with client devices 110 wish to purchase. Thus, applications 112 may also be used by a user to provide payments and transfers to another user or merchant, which may include transmitting feature data 114 to service provider server 120. For example, accounts and electronic transaction processing may include and/or utilize user financial information, such as credit card data, bank account data, or other funding source data, as a payment instrument when providing payment information to service provider server 120 for the transaction. Additionally, applications 112 may utilize a digital wallet associated with an account with a payment provider as the payment instrument, for example, through accessing a digital wallet or account of a user through entry of authentication credentials and/or by providing a data token that allows for processing using the account. Applications 112 may also be used to receive a receipt or other information based on transaction processing. Further, additional services may be provided via applications 112, including social networking, media posting or sharing, microblogging, data browsing and searching, online shopping, and other services available through service provider server 120. In some embodiments, the services provided via applications 112 may be associated with receipt of marketing, recommendations, next-best-actions, and/or other messages to increase customer engagement, alert and/or prevent against fraud, increase customer lifetime value, and/or otherwise provide services to users based on similarities and relationships determined from clustering operations of service provider server 120.

Client devices 110 may further include databases 116 stored on a transitory and/or non-transitory memory of each of client devices 110, which may store various applications and data and be utilized during execution of various modules of client devices 110. Databases 116 may include, for example, identifiers such as operating system registry entries, cookies associated with applications 112 and/or other applications, identifiers associated with hardware of client devices 110, or other appropriate identifiers, such as identifiers used for payment/user/device authentication or identification, which may be communicated as identifying users/client devices 110 to service provider server 120. Moreover, databases 116 may store feature data 114, which may be provided to service provider server 120 for use during clustering, intelligent decision-making and classification by DNN models, and/or providing recommendations, marketing, and the like based on the clustering and DNN models.

Client devices 110 include network interface components 118 adapted to communicate with service provider server 120 and/or another device or server. In various embodiments, network interface components 118 may each include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Service provider server 120 may be maintained, for example, by an online service provider, which may provide operations for use of services provided by service provider server 120 including account and electronic transaction processing services. In this regard, service provider server 120 includes one or more processing applications which may be configured to interact with client devices 110 to provide computing and customer services based on clustering using an embedding layer and embeddings determined from a DNN model. In various embodiments, use of the clustering may be used to provide information, messages, and/or computing services to users and other entities of service provider server 120. In one example, service provider server 120 may be provided by PAYPAL®, Inc. of San Jose, Calif., USA. However, in other embodiments, service provider server 120 may be maintained by or include another type of service provider.

Service provider server 120 of FIG. 1 includes a record clustering application 130, service applications 122, a database 126, and a network interface component 128. Record clustering application 130 and service applications 122 may correspond to executable processes, procedures, and/or applications with associated hardware. In other embodiments, service provider server 120 may include additional or different modules having specialized hardware and/or software as required.

Record clustering application 130 may correspond to one or more processes to execute modules and associated specialized hardware of service provider server 120 to provide computing services to users including those associated with clustering data records and the like for use in making associations and identifying relationships to provide additional information to users. In this regard, record clustering application 130 may correspond to specialized hardware and/or software used by a user associated with client devices 110 to utilize one or more services for data record clustering using deep embeddings from one or more DNNs including LSTM architectures. In this regard, record clustering application 130 may utilize data records 132 with deep neural network (DNN) models 134 in order to train DNN models 134 or cluster data records 132 using DNN models 134.

For example, DNN models 134 may initially be trained using training data and features determined and/or extracted from data records 132. In this regard, DNN models 134, once trained, may be used for clustering additional ones of data records 132, such as by using embeddings of an embedding layer for DNN models 134 with a clustering operation trained and optimized for DNN models 134. DNN models 134 may be trained to provide a predictive output, such as a score, likelihood, probability, or decision, associated with a particular classification or categorization learned from the training data. For example, DNN models 134 may include DNN, ML, or other AI models trained using training data associated with data records 132. When building DNN models 134, training data may be used to generate one or more classifiers and provide recommendations, predictions, or other outputs based on those classifications and an ML or NN model algorithm and/or trainer, such as an LSTM recurrent neural network architecture. Use of an LSTM architecture may provide benefits for temporal-based predictions for data that may change over a time period and/or predictions that may be time-sensitive.

The training data may be used to determine features 135, such as through feature extraction to determine features 135 from the input training data. For example, ML models for DNN models 134 may include one or more of layers 136, including an input layer, a hidden layer, and an output layer having one or more nodes, however, different layers may also be utilized. As many hidden layers as necessary or appropriate may be utilized and the hidden layers may include one or more encoding and/or embedding layers used to generate vectors from feature data of data records 132 that may be clustered using clustering process 137. Each node within a layer is connected to a node within an adjacent layer, where a set of input values may be used to generate one or more output values or classifications. Within the input layer, each node may correspond to a distinct attribute or input data type that is used to train DNN models 134, for example, using feature or attribute extraction with data records 132.

Thereafter, the hidden layer(s) may be trained with these attributes and corresponding weights using a DNN algorithm, computation, and/or technique. For example, each of the nodes in the hidden layer generates a representation, which may include a mathematical computation (or algorithm) that produces a value based on the input values of the input nodes. The DNN, ML, or other AI architecture and/or algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node(s) to produce one or more output values for DNN models 134 that attempt to classify and/or categorize the input feature data and/or data records (e.g., for a user, account, activity, etc., which may be a predictive score or probability). This may be done by taking output values at the output layer and using one-hot encoding for categorization. Thus, when DNN models 134 are used to perform a predictive analysis and output, the input may provide a corresponding output based on the classifications trained for DNN models 134.

Thus, DNN models 134 may be trained by using training data associated with data records 132 and a feature extraction of training features, such as features from data records 132. By providing training data to train DNN models 134, the nodes in the hidden layer(s) may be trained (adjusted) such that an optimal output (e.g., a classification) is produced in the output layer based on the training data. By continuously providing different sets of training data and penalizing DNN models 134 when the output of DNN models 134 is incorrect, DNN models 134 (and specifically, the representations of the nodes in the hidden layer) may be trained (adjusted) to improve its performance in data classification. Adjusting DNN models 134 may include adjusting the weights associated with each node in the hidden layer. During training, additional features may be used. For example, a distribution-wise objective function, such as normal distribution and/or Weibull distribution, may be used to configure and/or set cluster membership and/or parameters for cluster membership. The distribution-wise object function may be used to change or set parameters for how clusters and membership of data points, records, or other data within those clusters are created. Thus, the distribution may be used to control assignments of data and/or data points into different clusters and may be configurable by the framework for training DNN models 134.

Additionally, automatic hyperparameter selection of the number of resulting clusters may be performed. In place of conventionally having a model pick the number of resulting clusters, using the elbow method, and/or based on mean squared error, the framework for training DNN models 134 may allow for use of a silhouette score to automatically select or set a number of clusters used for clustering process 137. A silhouette score or coefficient may be used as a metric to determine how well a clustering technique is performing at clustering data points, such as data records 132 and/or other associated data (e.g., users, accounts, activities, etc.). The silhouette score may be used to determine if clusters are well separated and distinguished, clusters are indifferent or that a distance between clusters (and/or data points in those clusters) is not significant, and/or is cluster incorrectly assigned. As such, the silhouette score may be used to automatically set the number of clusters in a separated and distinguished manner. Using these operations for clustering process 137, an embedding layer may be trained and reconfigured for clustering process 137 using the training data.

Thus, the training data may be used as input/output data sets that allow for DNN models 134 to make classifications based on input attributes, as well as the parameters for clustering process 137. Once trained, an embedding layer or other hidden layer of DNN models 134 may be used with clustering process 137 to cluster further ones of data records 132. For example, data for a set of features used as input to DNN models 134 (e.g., feature data from data records 132) may be used as input, where DNN models 134 may be cut or separated at the embedding layer for clustering process 137 in order to obtain embeddings for the features from the data. The embeddings may correspond to vectors, which reduce the dimensionality in the number of individual data points or pieces that correspond to the input data for the set of features (e.g., by creating a vector of n-dimensionality for n number of features). This allows the vector to be clustered having a temporal factor or dimension to the underlying data for the features, as well as reducing the dimension of the individual data points requiring clustering. Once clustered, the clusters and/or cluster memberships may be provided to service applications 122 in order to provide one or more services, offers, notification, or messages associated with relationships and associations detected from cluster membership in the clusters.

Service applications 122 may correspond to one or more processes to execute modules and associated specialized hardware of service provider server 120 to process a transaction or provide another service to customers, merchants, and/or other end users and entities of service provider server 120. In this regard, service applications 122 may correspond to specialized hardware and/or software used by service provider server 120 to providing computing services to users, which may include electronic transaction processing and/or other computing services using accounts provided by service provider server 120. In some embodiments, service applications 122 may be used by users associated with client devices 110 to establish user and/or payment accounts, as well as digital wallets, which may be used to process transactions. In various embodiments, financial information may be stored with the accounts, such as account/card numbers and information that may enable payments, transfers, withdrawals, and/or deposits of funds. Digital tokens for the accounts/wallets may be used to send and process payments, for example, through one or more interfaces provided by service provider server 120. The digital accounts may be accessed and/or used through one or more instances of a web browser application and/or dedicated software application executed by client devices 110 and engage in computing services provided by service applications 122. Computing services of service applications 122 may also or instead correspond to messaging, social networking, media posting or sharing, microblogging, data browsing and searching, online shopping, and other services available through service provider server 120.

In various embodiments, service applications 122 may be desired in particular embodiments to provide features to service provider server 120. For example, service applications 122 may include security applications for implementing server-side security features, programmatic client applications for interfacing with appropriate application programming interfaces (APIs) over network 140, or other types of applications. Service applications 122 may contain software programs, executable by a processor, including a graphical user interface (GUI), configured to provide an interface to the user when accessing service provider server 120 via one or more of client devices 110, where the user or other users may interact with the GUI to view and communicate information more easily. In various embodiments, service applications 122 may include additional connection and/or communication applications, which may be utilized to communicate information to over network 140.

Additionally, service applications 122 may be used to provide a service or other information to one or more users or accounts based on clustering performed by record clustering application 130. In this regard, service applications 122 may be used to provide a next action 124, such as a next-based-action to execute with a user or account, based on cluster membership by the user, account, or data record associated with the user/account in a cluster determined from record clustering application 130. Next action 124 may include provide a computing or customer service to a user in order to increase the user's total customer lifetime value. The cluster membership may be used to determine over-time customer behaviors and/or optimize decisions for actionable insights. Thus, next action 124 may include providing a service and/or may further include transmitting or providing a message, notification, offer, or the like for the corresponding next-best-action.

Additionally, service provider server 120 includes database 126. Database 126 may store various identifiers associated with client devices 110. Database 126 may also store account data, including payment instruments and authentication credentials, as well as transaction processing histories and data for processed transactions. Database 126 may store financial information or other data generated and stored by record clustering application 130. Database 126 may also include data and computing code, or necessary components for DNN models 134 and/or clustering process 137. Database 126 may also include data records 132, which may include feature data 114 provided by client devices 110.

In various embodiments, service provider server 120 includes at least one network interface component 128 adapted to communicate client devices 110 and/or other devices or server over network 140. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Network 140 may be implemented as a single network or a combination of multiple networks. For example, in various embodiments, network 140 may include the Internet or one or more intranets, landline networks, wireless networks, and/or other appropriate types of networks. Thus, network 140 may correspond to small scale communication networks, such as a private or local area network, or a larger scale network, such as a wide area network or the Internet, accessible by the various components of system 100.

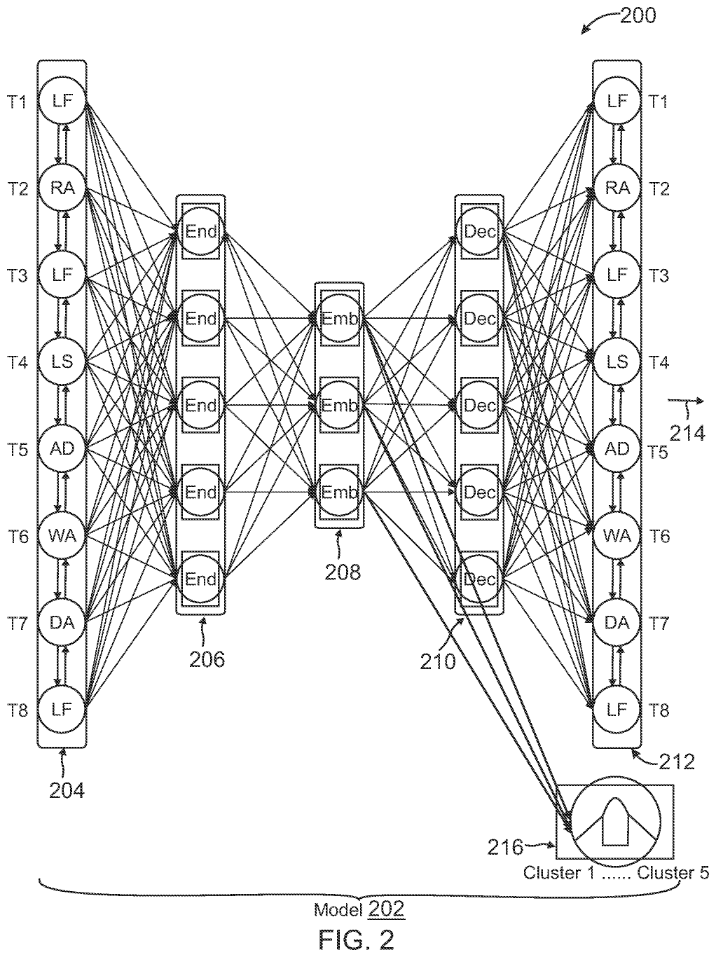

FIG. 2 is an exemplary deep neural network 200 having an embedding layer used for clustering of data records, according to an embodiment. DNN 200 includes a model 202 that includes different layers trained from input training features to provide an output classification at an output layer, which may be performed based on values or scores determined from the hidden layers of model 202. In this regard, an embedding layer 208 may be used for deep clustering using a distribution-wise objective function with parameter tuning using silhouette scores.

Conventionally, an output of an embedding layer may be used as input for a k-means clustering or other similar clustering algorithm, where the number of clusters are identified using mean squared error or elbow method, or hyperparameter selection by a modeler. However, this conventional clustering does not consider temporal factors and information for input feature data and corresponding features, and therefore may not be applied to or compatible with sequential, changing, and/or time-based data. In DNN 200, model 202 may utilize additional features and parameters for training and clustering so that temporal information may be considered during determination of cluster membership for clusters generated using embeddings determined using a hidden layer of model 202.

In this regard, model 202 includes an input layer 204, an encoding layer 206, an embedding layer 208, a decoding layer 210, and an output layer 212, as well as an output classification 214. Further, model 202 may be used to perform clustering 216, where clustering 216 is determined from trained embedding layer 208. Input layer 204 may correspond to a layer that takes input data for features, such as account activity features shown in DNN 200. The data may be parsed and processed, and feature data for the particular features of model 202 extracted and used as input at input layer 204. Using the trained weights, values, and mathematical relationships between nodes in input layer 204 and nodes in encoding layer 206, encoding may be generated as initial mathematical representations (e.g., vectors) of the input feature data. Encoding layer may then be connected to embedding layer 208, which may generate embeddings of the feature data from the encodings. Decoding layer 210 may be used to create decisions, such as based on the trained weights and relationships between nodes, which are provided as output scores, values, or other data at output layer 212. Using one-hot encoding or other data conversion operation, output classification 214 may be provided as the output of model 202 based on the data from output layer 212.

Initially after feature extraction and/or transformation, training data and a DNN architecture may perform cross validation, hyperparameter tuning, model selection, and the like for training model 202. Once the training data and DNN, ML, or other AI model algorithm and framework have been prepared, model training/testing may be performed to train model 202. The ML model may be trained using the extracted features and DNN, ML, or other AI algorithm, such as an LSTM recurrent neural network architecture, although other ML or NN algorithms and techniques may also be used. Model training/testing may also include feedback loops and tuning by a data scientist or modeler, which may allow for more accurate predictions and/or classifications. Once trained, deployed model 202 may be executed to perform classifications, as well as clustering 216 of embeddings into clusters for analysis and proactive or actionable insight execution.

When executing model 202, feature transformation may then be used with the input data and model 202 to generate a prediction, classification, and/or categorization, which may correspond to a predictive score or probability associated with the input data. The input data may correspond to one or more data records, which each have different input features having a dimensionality or number of features. As shown in DNN 200, moving from input layer 204 to encoding layer 206, as well as from encoding layer 206 to embedding layer 208, the dimensionality of such input features for one or more data records is reduced. For example, encoding layer 206 may have five encodings generated from eight input features provided by input layer 204, while embedding layer 208 may generate three embeddings from the five encodings provided by encoding layer 206. This allows for reduction in the dimensionality of the input feature data into one or more embeddings, which may correspond to vectors having a dimensionality of features or variables associated with the input feature data from input layer 204.

In order to provide more accurate and time-sensitive clustering, such as based on temporal information where feature data may change over a time period or at different time-steps, during training and clustering, model 202 may be used. Model 202 may use an LSTM architecture, which allows for use with sequential and/or temporal data and features. Thus, model 202 may be built and trained using such data to account for changes and/or time-based data. Further, an objective function may be used for determination of cluster membership and cluster loss, where the objective function uses a distribution operation including normal distribution and/or Weibull distribution. Thus, the distribution-wise objective function may be used in place of k-means clustering or other clustering algorithm that merely analyze data at a snapshot in time or a specific time, instead of temporal data that may change over a time period. This allows for clustering 216 to be based on temporal data.

Use of a distribution-wise objective function may be selected based on the input features and/or desired output of model 202. For example, a normal distribution may be used with the objective function for purposes of clustering accounts, users, or activities that may have a fairly bell-shaped curve and/or extend over a range. This may be chosen with the assumption that many data points or records fall within the middle of the data range and that the tails or ends of such data ranges and curves include clusters with few data points. However, in data sets that include very low numbers of certain users, accounts, or activities (e.g., fraud detection or other anomaly detection), a Weibull distribution may be used to better cluster unexpected behaviors.

This distribution-wise objective function may therefore be used when training to identify cluster membership and/or cluster loss using a loss function, which allows for tuning of the layers of model 202 to better cluster and reduce loss. However, the number of clusters may be required to be set as a parameter, such as a hyperparameter usually set by a modeler or calculated using mean squared error. Instead with model 202, a silhouette score may be used to determine how “good” or accurate clustering is and adjust the number of clusters until the silhouette score identifies the clusters as sufficiently distinguished and appropriate. Clusters may continually be broken into less clusters or combined as per the silhouette score, which allows automatic tuning and setting of the number of clusters.

Clustering 214 may then be used with input data at input layer 204 by taking the embeddings from embedding layer 208 and performing clustering using the number of clusters and the distribution-wise objective function. Clustering 216 may be performed in order to cluster embeddings and draw parallels or relationships between users, accounts, activities, or the like corresponding to the clustered embeddings (and corresponding data records used as input at input layer 204). Where embeddings fall into the same cluster, next-best-actions and other information may be determined based on similarities and predicted interests or similarities between those data points in each cluster. For example, for a user in a cluster with several other users that all utilize a specific computing service of a service provider (e.g., a credit extension, an account service, an application, a login flow, etc.), it may be predicted that the user would also be interested in that computing service.

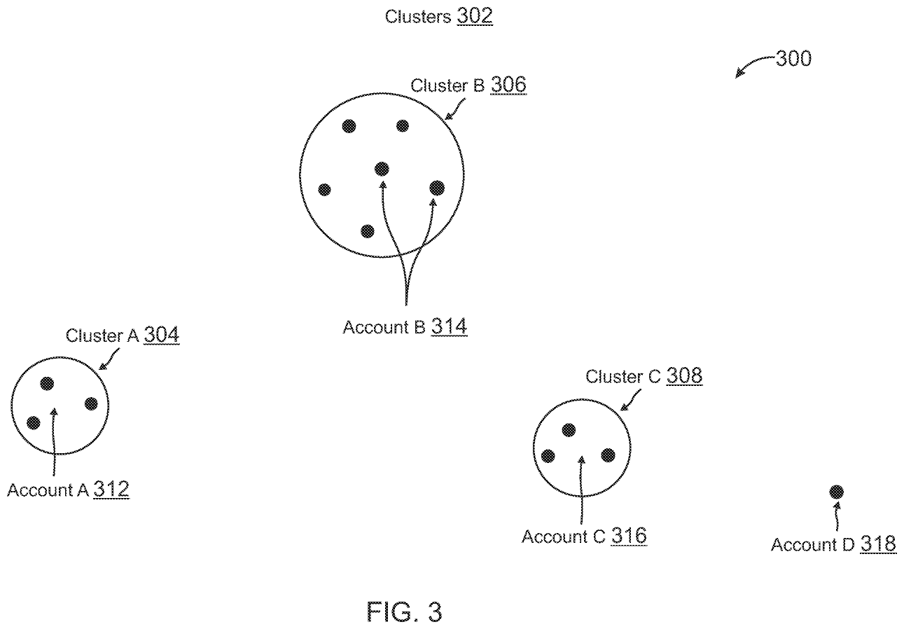

FIG. 3 is an exemplary diagram 300 of data record clustering that may be performed based on embeddings from an embedding layer of a deep neural network, according to an embodiment. Diagram 300 includes clusters 302 that may be generated by service provider server 120 discussed in reference to system 100 of FIG. 1 using the clustering operations discussed herein with DNN models. In this regard, service provider server 120 may optimize clusters 302 during training of a DNN, where membership in clusters 302 may be designated by embeddings from an embedding layer of a DNN.

Clusters 302 in diagram 300 include a cluster A 304, a cluster B 306, and a cluster C 308. Membership in clusters 302 may include accounts A 312, accounts B 314, and accounts C 316, with an unaffiliated account D 318 that may not fall into a cluster and/or be associated with a separate single account cluster. In diagram 300, generation of clusters 302 and/or cluster membership and cluster loss (e.g., where account D 318 is not clustered or properly clustered) may be configured during training using a distribution-wise objective function and use of silhouette scores. For example, diagram 300 includes accounts A 312 as the cluster membership for cluster A 304, accounts B 314 as the cluster membership for cluster B 306, and accounts C 316 as the cluster membership for cluster C 308, which may be trained for clustering based on the distribution-wise objective function in order to create embeddings used for clustering in clusters 302. Similarly, three (or four, where account D 318 corresponds to its own cluster) clusters are shown for clusters 302, such as based on a silhouette score, however, a higher or lower number of clusters may also be designated when training and/or clustering using the silhouette score.

The LSTM architecture or other DNN model may be used with data for a set of features processed by the DNN model to generate embeddings, which are used for determination of clusters 302 and cluster membership in clusters 302. For example, the DNN model may process the data for the features and provide vectors for embeddings of the data that reduce an overall dimensionality of the different data points, features, or the like in the data. The vectors may then be used for clustering into clusters 302. For example, the data may correspond to data records for accounts, such as account activity over a time period and therefore includes temporal information. Using the data records, accounts A 312 may be clustered together in cluster A 304, accounts B 314 in cluster B 306, and accounts C 316 in cluster C 308. Account D 318 may form a separate single account cluster or may fall outside of all clusters.

Using clusters 302, parallels and relationships between accounts may be determined. For example, all but one of accounts B 314 may utilize a mobile application with a service provider and share similar account activity over a time period, such as the history of mobile payments, while none of accounts A 312 and/or accounts C 316 use such an application. It may be determined that the one account of accounts B 314 that does not use this mobile application may benefit from installing and using the mobile application based on the history of mobile payments by that account and the activities of the rest of accounts B 314. Thus, a next-best-action may be predicted and be actionable to provide a service to the accounts in clusters 302 based on their cluster membership.

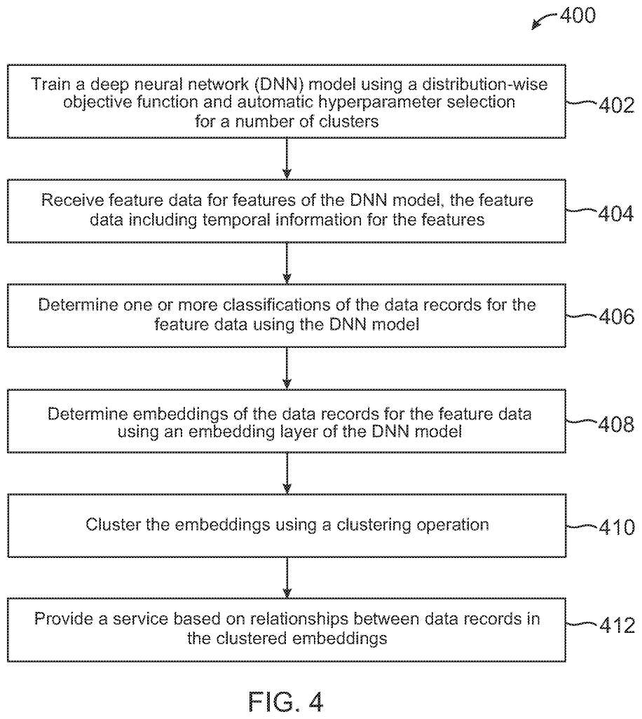

FIG. 4 is a flowchart 400 for clustering data vectors based on deep neural network embeddings, according to an embodiment. Note that one or more steps, processes, and methods described herein of flowchart 400 may be omitted, performed in a different sequence, or combined as desired or appropriate.

At step 402 of flowchart 400, a DNN is trained using a distribution-wise object function and automatic hyperparameter selection of the number of clusters. In order to train the DNN, such as using a LSTM recurrent neural network architecture, training data may be determined, which may correspond to input data utilized for an output prediction or classification. The training data may correspond to a particular set of data, such as data tables having rows for different data records of one or more users, entities, accounts, or activities, and columns for one or more features in a set of features to be provided as the input features and/or feature extraction for training the DNN model.

When training the DNN, an embedding layer and DNN model may be trained, adjusted, and/or have nodes reweighted using a distribution-wise objective model that is used to determine cluster membership and cluster loss (e.g., using a loss function) for clustering using embeddings from that embedding layer. For example, the embeddings may be taken as vectors that reduce the dimensionality of the input features' data into vectors more easily and/or efficiently clustered having a temporal dimension or factor based on changing or time-based input feature data. The objective function may utilize a distribution when calculating cluster membership and/or clustering different data points (e.g., embeddings and/or corresponding users, accounts, activities, or other associations with data records for those embeddings). The distribution may be configurable when training the DNN and may include a normal distribution, Weibull distribution, or the like.

At step 404, feature data for features of the DNN model are received, the feature data including temporal information for the features. For example, the DNN model may be deployed for classifications and/or predictive decision-making, where clustering using the embedding layer of the DNN may also be used for identifying cluster memberships of different data points, data records, or the like (e.g., users, accounts, etc., associated with data records). Feature data may therefore include one or more data records for processing. At step 406, one or more classifications of the data records for the feature data are determined using the DNN model. The classifications may correspond to an output of the DNN model, which may be predictive and/or used for predictive categorization. For example, a user or account may be designated as engaged or non-engaged, fraudulent or valid, gibberish text used by fraudsters or valid usernames/accounts, and the like.

At step 408, embeddings of the data records for the feature data are determined using the embedding layer of the DNN model. Using the input feature data, the DNN may be cut or stopped at the embedding layer, and the embeddings of the data may be obtained for clustering. The embeddings may correspond to a vector of n-dimensionality, which may be reduced from the number of original features and data points for the feature data. Thus, the embeddings allow for more efficient clustering by requiring lower dimensional data points. Further, the embeddings allow for a time-based factor and/or data to be included in the embeddings and do not focus on a snapshot or single point in time.

At step 410, the embeddings are clustered using a clustering operation. The clustering operation may utilize the established clustering protocols, such as the distribution-wise objective function, for determination of cluster membership. Further, the number of cluster may be set using the silhouette function in order to perform automatic hyperparameter selection without requiring modeler setting of the number of clusters and/or using means squared error/elbow method for cluster number setting. Thus, the embeddings may be clustered having a temporal dimension or factor from the data. At step 412, a service is provided based on relationships between data records in the clustered embeddings. The service may be provided by identifying any relationships between the underlying data points in the clusters. For example, clustered data points may share significant similarities but also have differences, which allows for analysis and cross-linking those shared and different traits, features, data records, and the like. In some embodiments, this may include identifying next-best-actions to enhance customer engagement and/or customer lifetime value based on services and information that may be relevant to users, accounts, or the like that share cluster membership.

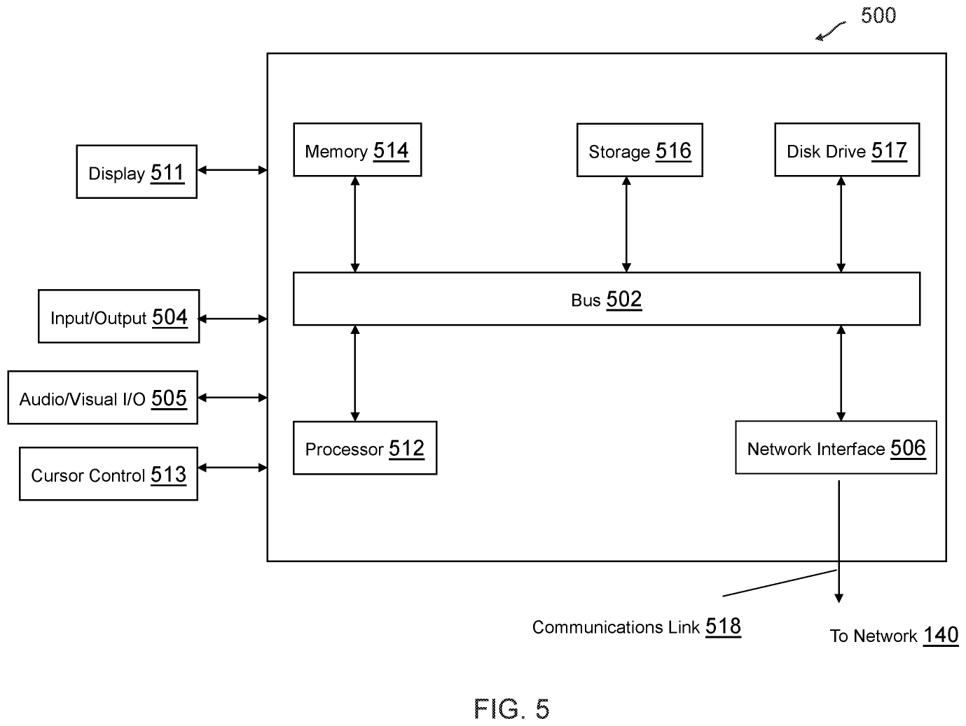

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A service provider system comprising:
a non-transitory memory; and
one or more hardware processors coupled to the non-transitory memory and configured to read instructions from the non-transitory memory to cause the service provider system to perform operations comprising:
obtaining data for a set of features associated with a plurality of data records, wherein the set of the features comprise temporal information for the plurality of data records;
utilizing a deep neural network model to classify the data into one or more classifications in an output layer of the deep neural network model;
determining, from the data, embeddings for the set of the features for the plurality of data records using an embedding layer of the deep neural network model, wherein each of the embeddings comprises a vector reducing a dimensionality of the data for the set of the features for each of the plurality of data records;
clustering the plurality of data records into clusters using the embeddings and a clustering function; and
identifying relationships between the plurality of data records from the clusters.

2. The service provider system of claim 1, wherein the deep neural network model uses a long short-term memory (LSTM) recurrent neural network architecture.

3. The service provider system of claim 1, wherein the temporal information comprises data points for each of the features in the set of the features collected over a time period.

4. The service provider system of claim 1, wherein the data comprises at least one data table having rows and columns, and wherein each row represents one of the plurality of data records and each column represents one of the features from the set of the features.

5. The service provider system of claim 4, the plurality of data records are associated with at least one of accounts, users, activities, or transactions corresponding to an online service provider, and wherein the features from the set of the features are associated with at least one of customer data, fraud data, or transaction data corresponding to the online service provider.

6. The service provider system of claim 1, wherein prior to obtaining the data, the operations further comprise:
training the deep neural network model, wherein the training utilizes a distribution-wise objective function to calculate cluster membership and clustering loss associated with the embedding layer.

7. The service provider system of claim 6, wherein the distribution-wise objective function comprises one of a normal distribution or a Weibull distribution.

8. The service provider system of claim 6, wherein the distribution-wise objective function is selectable via a model training framework during the model training based on at least one of a user input, one or more desired clusters parameters, or input training data.

9. The service provider system of claim 6, wherein the training comprises:
performing an automatic hyperparameter selection of a number of clusters for output by the embedding layer of the deep neural network model during the training using a silhouette score for cluster performance evaluation.

10. The service provider system of claim 1, wherein the identifying the relationships is based on classifications of the plurality of data records that are output by the deep neural network model.

11. A method comprising:
generating embeddings for features of data records of a service provider using an embedding layer of a deep neural network model, wherein each of the embeddings comprises a vector of n-dimensionality associated with a number of the features, and wherein the features comprise at least one temporal factor;
clustering the data records into clusters using the embeddings and a clustering function, wherein the number of the clusters is automatically set as a hyperparameter during a training of the deep neural network model;
determining classifications of the data records in each of the clusters; and
determining a time-based action to execute with one of the data records in a corresponding one of the clusters based on the classifications of the data records in the corresponding one of the clusters.

12. The method of claim 11, wherein the deep neural network model is trained using a long short-term memory (LSTM) recurrent neural network architecture during the training.

13. The method of claim 11, wherein the deep neural network model uses a distribution-wise objective function during the training for at least the embedding layer.

14. The method of claim 13, wherein the distribution-wise objective function uses one of a normal distribution or a Weibull distribution with an objective function.

15. The method of claim 11, wherein the number of the clusters is automatically set as the hyperparameter during the training using a silhouette score.

16. The method of claim 11, wherein the time-based action comprises a next-based action for the one of the data records based on past actions of the one of the data records over a time period for the temporal factor.

17. A non-transitory machine-readable medium having stored thereon machine-readable instructions executable to cause a machine to perform operations comprising:
receiving feature data for model features of a long short-term memory (LSTM) neural network model, wherein the feature data is associated with a plurality of data records and comprises temporal data for the plurality of data records over a time period;
generating, from the feature data using a hidden layer of the LSTM neural network model, an embedding for each of the plurality of data records, wherein the embedding comprises a vector reducing a dimensionality of a number of the model features having the feature data for a corresponding one of the plurality of data records, and wherein the hidden layer is trained using a distribution-wise objective function during a training of the LSTM neural network model;
clustering the plurality of data records into clusters using the embeddings and a clustering function, wherein a number of clusters for the clustering function is automatically set as a hyperparameter during the training of the LSTM neural network model; and
determining a next-best-action to execute with one of the plurality of data records based on the clusters, wherein the next-best-action is associated with the temporal data for the plurality of data records in a corresponding cluster for the one of the plurality of data records.

18. The non-transitory machine-readable medium of claim 17, wherein the distribution-wise objective function comprises one of a normal distribution or a Weibull distribution, and wherein the number of clusters for the clustering function is automatically set using a silhouette score.

19. The non-transitory machine-readable medium of claim 17, wherein the feature data further comprises customer data over the time period associated with customers of a service provider.

20. The non-transitory machine-readable medium of claim 19, wherein the clusters comprise a membership distribution used to segment the customers of the service provider to identify the next-best-action.
